(19) United States
(12) Patent Application Publication
(10) Pub. No.: US 2024/0267388 A1
(43) Pub. Date: Aug. 8, 2024

(54) ESTABLISHING CONNECTIONS BETWEEN NODES BASED ON A PREDETERMINED SEQUENCE OF PATH KNOCKS BEING PERFORMED

(71) Applicant: International Business Machines Corporation, Armonk, NY (US)

(72) Inventors: Mudhakar Srivatsa, White Plains, NY (US); Satishkumar Sadagopan, Leawood, KS (US); Mathews Thomas, Flower Mound, TX (US); Utpal Mangla, Toronto (CA); Gerald Coon, Durham, NC (US); Dinesh C. Verma, New Castle, NY (US)

(21) Appl. No.: 18/105,141

(22) Filed: Feb. 2, 2023

(51) Int. Cl. H04L 9/40

(52) U.S. Cl. CPC H04L 63/126

(57) ABSTRACT

A computer-implemented method, according to one embodiment, includes determining whether a predetermined sequence of knocks has been performed by a requesting node to other nodes of a network along existing paths between the requesting node and the other nodes. In response to a determination that the predetermined sequence of knocks has been performed, a connection is established between the requesting node and a first of the other nodes. A computer program product, according to another embodiment, includes a computer readable storage medium having program instructions embodied therewith. The program instructions are readable and/or executable by a computer to cause the computer to perform the foregoing method. A system, according to another embodiment, includes a processor, and logic integrated with the processor, executable by the processor, or integrated with and executable by the processor. The logic is configured to perform the foregoing method.

### BACKGROUND

The present invention relates to node connectivity within a network, and more specifically, this invention relates to establishing connections between nodes of a network in response to a determination that a predetermined sequence of knocks has been performed between the nodes via paths existing between the nodes of the network.

Networks typically include a plurality of nodes, which may be any known type of device, e.g., computers, servers, processing circuits, controllers, etc. An enterprise network is a type of network that enables communication within a specific type of network, such as a corporate network. An enterprise network enables communication, e.g., data and/or resource sharing, between nodes of the enterprise network. Security protocols are used to establish secure connections between these nodes of the enterprise network. More specifically, some of these security protocols are used for purposes of preventing unauthorized devices from being connected to a node of the enterprise network, e.g., a device attempting to connect to one or more of the nodes of the enterprise network to initiate a cyber-attack.

### SUMMARY

A computer-implemented method, according to one embodiment, includes determining whether a predetermined sequence of knocks has been performed by a requesting node to other nodes of a network along existing paths between the requesting node and the other nodes. In response to a determination that the predetermined sequence of knocks has been performed, a connection is established between the requesting node and a first of the other nodes.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the method of FIG. 2A, in accordance with one embodiment of the present invention.

FIGS. 3A-3F depict a network, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for establishing connections between nodes of a network in response to a determination that a predetermined sequence of knocks has been performed between the nodes via paths existing between the nodes of the network.

In one general embodiment, a computer-implemented method includes determining whether a predetermined sequence of knocks has been performed by a requesting node to other nodes of a network along existing paths between the requesting node and the other nodes. In response to a determination that the predetermined sequence of knocks has been performed, a connection is established between the requesting node and a first of the other nodes.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as node path knock determination module of block 150 for establishing connections between nodes of a network in response to a determination that a predetermined sequence of knocks has been performed between the nodes via paths existing between the nodes of the network. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

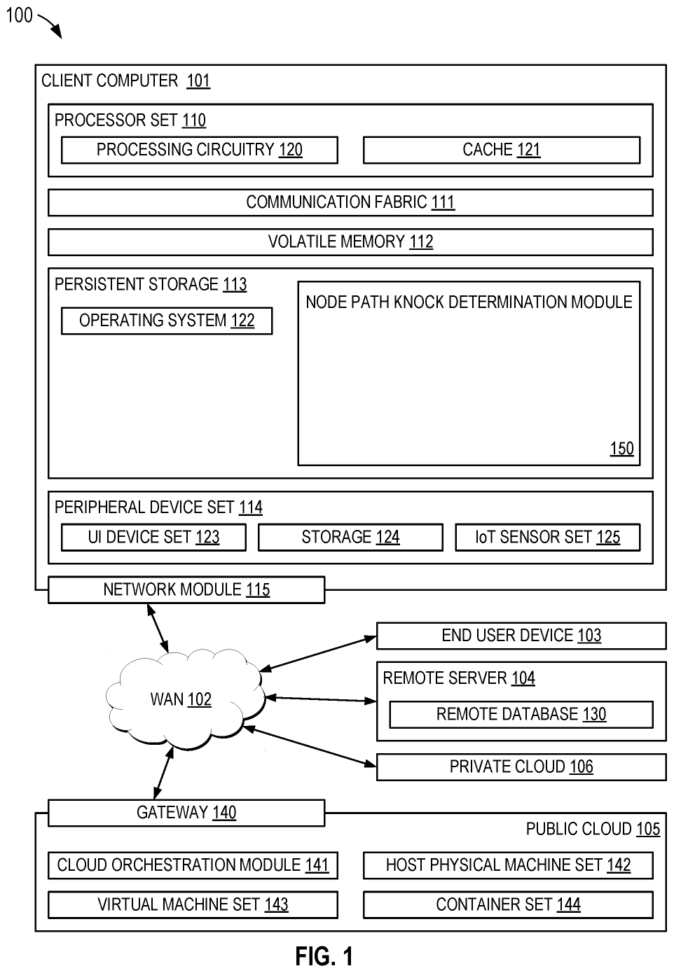

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, networks typically include a plurality of nodes, which may be any known type of device, e.g., computers, servers, processing circuits, controllers, etc. An enterprise network is a type of network that enables communication within a specific type of network, such as a corporate network. An enterprise network enables communication, e.g., data and/or resource sharing, between nodes of the enterprise network. Security protocols are used to establish secure connections between these nodes of the enterprise network. More specifically, some of these security protocols are used for purposes of preventing unauthorized devices from being connected to a node of the enterprise network, e.g., a device attempting to connect to one or more of the nodes of the enterprise network to initiate a cyber-attack. However, in the process of enforcing conventional security protocols, connections between nodes are delayed. This compromises performance and user satisfaction within enterprise networks in which there is a demand and need to support connections from any node, e.g., device, at any place, and at any time.

In sharp contrast to the deficiencies of the conventional techniques described above, the techniques of embodiments and approaches described herein enhance perimeter security of network. In some approaches, these techniques enhance the performance within an enterprise that is implementing tunneled networking such as a software defined-wide area network (SD-WAN) overlay or VPNs, to support a culture where employees, partners, contractors, etc., of an enterprise demand the need to support connections from any device, any place, any time, etc. In tunneled networking such as an SD-WAN, where nodes are connected via tunneled paths, various embodiments and approaches described herein include causing a server to allow a client to establish connection based on knocking a pre-determined sequence of paths in the network, before gaining connection to the server. This strengthens the security of the network, and more specifically the perimeter security of the network, by setting a complexity of knocking on nodes according to a predefined accepted sequence to establish connectivity.

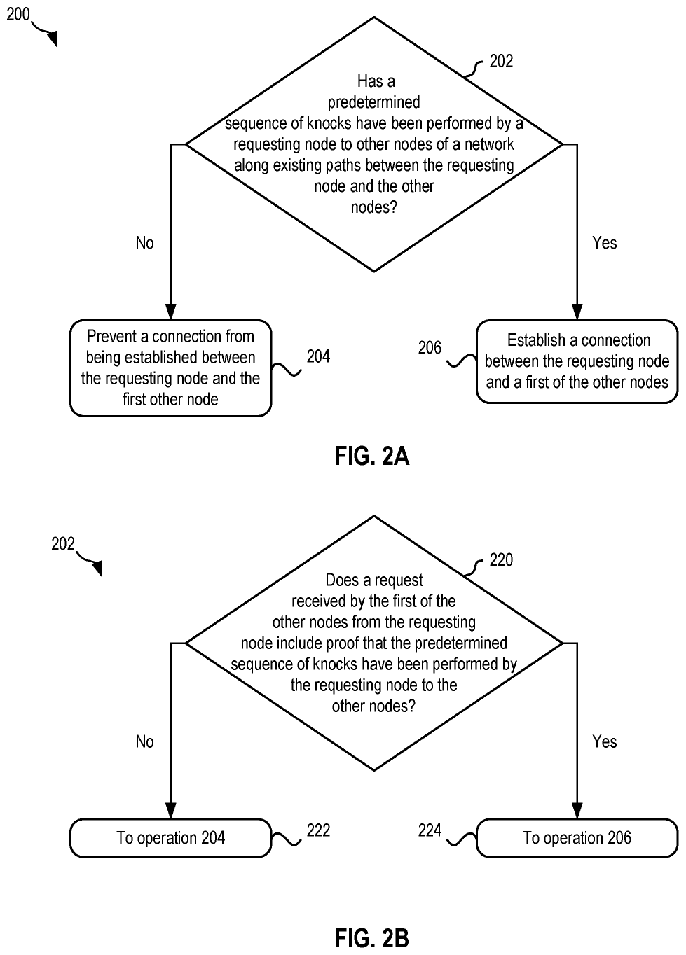

Now referring to FIG. 2A, a flowchart of a method 200 is shown according to one embodiment. The method 200 may be performed in accordance with the present invention in any of the environments depicted in FIGS. 1-3F, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Referring now to FIG. 2A, it may be prefaced that method 200 may be performed in a known type of network that includes two or more nodes. In some preferred approaches, the network may include tunneled networking such as an SD-WAN, where nodes of the network may be tunneled nodes that are connected via tunnel paths. In another preferred approach, the network may include a tunneling software defined network (SDN). Predetermined paths may, in some approaches, exist between the nodes of the network, e.g., due to a nature of tunnels in software defined networking overlays. In some approaches, pre-determined tunneling paths exist between each of the nodes of the network. In some other approaches, pre-determined paths exist between a portion of the nodes of the network. Although such paths may exist between the nodes, in some approaches, method 200 optionally includes causing one or more paths to be established between nodes, which may be used for one or more operations described herein.

Decision 202 includes determining whether a predetermined sequence of knocks has been performed by a requesting node, e.g., which may be a client node, to other nodes of a network along existing paths between the requesting node and the other nodes. For context, the predetermined sequence is preferably only known by trusted nodes and/or entities of the network and/or is preferably not known outside of the network. This way, the requesting node is able to, by performing the predetermined sequence of knocks, verify its identity as not being an untrustworthy actor attempting to launch a cyber-attack on the network by connecting to one of the nodes of the network. Otherwise, nodes that are attempting to connect to a first of the other nodes but do not know the predetermined sequence of knocks, are denied connection, e.g., in response to a determination that the predetermined sequence has not been performed, to the first other node which appears closed and secure. A node that is knocked on, e.g., such as the “first other node,” the “second other node,” the “third other node,” mentioned elsewhere below, may be caused to monitor communication traffic along the tunneling paths that exist between the requesting node and the monitoring node. For example, this monitoring may include studying a firewall log and/or performing packet capture techniques that would become appreciated to one of ordinary skill in the art upon reading the descriptions herein. This way, a node that is knocked on, e.g., such as the first other node, may determine whether the requesting node is qualified to connect to the node, e.g., qualified based on the requesting node presenting proof that the requesting node has performed the predetermined sequence of knocks. Furthermore, each “knock” performed by the requesting sequence may, in some approaches, be a handshake being performed by the requesting node to the requested node, that communicates information to the node that is being knocked on. The information may include, e.g., a request to connect, proof of knocks previously performed by the requesting node, credentials, a request for the knocked on node to provide marking that the knock was performed by the requesting node, etc., which, in some approaches, may be included in a packet. For context, and as will be described in greater detail elsewhere below, the predetermined sequence of knocks may include one or more of, e.g., a single knock being performed by the requesting node to one of the other nodes and then a single knock being performed by the requesting node to another one of the other nodes, a plurality of knocks being performed on the same node, a plurality of packets being sent to the same node over a series of sequentially performed knocks, a plurality of knocks being performed by the requesting node to one of the other nodes and then a single knock being performed by the requesting node to another one of the other nodes, a plurality of knocks being performed by the requesting node to one of the other nodes and then a plurality of knocks being performed by the requesting node to another one of the other nodes, etc. It should be noted that the “requesting node” is preferably a node of the network that is performing the predetermined sequence of knocks, while the “other nodes” are preferably all or a portion of the nodes of the network that are potentially being knocked on during the requesting node performing the knocking. It may also be noted that a “first of the other nodes” is described in various approaches herein to be a target node, e.g., one of the “other nodes” that the requesting node is attempting to connect to by performing the predetermined sequence of knocks.

In some approaches, determining whether the predetermined sequence of knocks has been performed may include determining whether a request, e.g., a knock, received by the first other node from the requesting node includes proof that the predetermined sequence of knocks has been performed by the requesting node to the other nodes of the network. For example, Looking to FIG. 2B, exemplary sub-operations for determining whether the predetermined sequence of knocks has been performed are illustrated in accordance with one embodiment, one or more of which may be used to perform decision 202 of FIG. 2A. For example, sub-operation 220 includes determining whether the request received by the first other node from the requesting node includes proof that the predetermined sequence of knocks has been performed by the requesting node to the other nodes of the network. However, it should be noted that the sub-operations of FIG. 2B are illustrated in accordance with one embodiment which is in no way intended to limit the invention. The “proof” may be predetermined information included in the request received by the first other node, that verifies that the requesting node did perform the predetermined sequence of knocks on the other nodes. In some approaches, the proof includes predetermined source routing. For example, a route of knocks previously performed by the requesting node to the other nodes along the existing paths may be encapsulated in a packet header included in the received request. In other words, the requesting node uses the information of the packet header to declare one or more paths taken by the requesting node potentially before sending the request, e.g., before performing the “final knock”. One or more techniques, that would become apparent to one of ordinary skill in the art upon reading the descriptions herein, may be used to update a packet header of the requesting node to include such proof. The proof may, in some approaches, additionally and/or alternatively include predetermined path marking, e.g., predetermined path marking being included in the received request. For context, in some of such approaches, the path marking may indicate a route of knocks previously performed by the requesting node to the other nodes along the existing paths before sending the request to the first other node. This is a marking based scheme, which may include the other nodes that are knocked on by the requesting node issuing a predetermined type of stamp to a confirmation returned to the requesting node, e.g., a stamp is returned to the requesting node by each of the other nodes that are knocked on subsequent to being knocked on by the requesting node.

In response to a determination that the proof is included in the received request, e.g., as illustrated by the “Yes” logical path of sub-operation 220, the method optionally continues to operation 206, e.g., see operation 224. In contrast, in response to a determination that the proof is not included in the received request, e.g., as illustrated by the “No” logical path of sub-operation 220, the method optionally continues to operation 204, e.g., see operation 222.

With reference again to FIG. 2A, a history of knocks performed by the requesting node and/or other nodes of the network may be recorded, e.g., in a predetermined file associated with the node. In some approaches, such a file may be considered for determining whether the requesting node is attempting to effectually guess the predetermined sequence of knocks. For example, in some approaches, method 200 may include determining from a history of the requesting node, whether the node has previously performed sequences of knocks that do not match any predetermined sequence of knocks used in the network. In response to a determination that the node has previously performed a predetermined number of sequences of knocks that do not match any predetermined sequence of knocks used in the network, the requesting node may be denied connection to the first other node.

Various illustrative examples of the predetermined sequence of knocks are described below. It may be prefaced that the “other nodes” of the network may, in some approaches, be predetermined. For example, in some preferred approaches, each of the knocks of the predetermined sequence are to be performed on predetermined nodes of the other nodes. In contrast, in some other approaches, one or more knocks of the predetermined sequence of knocks may be performed on any of the other nodes of the network, provided that the predetermined sequence of knocks is performed. For example, in some approaches, the predetermined sequence of knocks may include the requesting node performing a predetermined number of knocks (in any order) on any three of the other nodes, e.g., a second of the other nodes, a fifth of the other nodes, a seventh of the other nodes, etc., before requesting to connect to the first other node. It should be prefaced however, that the predetermined sequence of knocks is preferably performed on predetermined nodes. This helps to ensure that a requesting node that does not know the predetermined sequence of knocks is not able to spam requests out to different ones of the other nodes in an attempt to by chance correctly perform the predetermined sequence of knocks.

In one approach, the predetermined sequence of knocks includes knocking on a predetermined second one of the other nodes before sending the request to the first other node. It should be noted that, in some approaches, the request is itself a knock performed on the first other node, and therefore the requesting knock performed by the requesting node on the target node may be a portion of the knocks of the predetermined sequence of knocks. For example, assuming that the predetermined sequence of knocks includes knocking on the predetermined second other node before sending the request to the first other node, the predetermined sequence of knocks may include the requesting node knocking on the predetermined second other node, e.g., one knock, at least one knock, a predetermined number of knocks, etc., before the requesting nodes knocks on the first other node, e.g., issues a request to connect to the target node. In some other approaches, the request is realized, e.g., received, prior to one or more of the knocks being performed. Accordingly, in one or more of such approaches, the connection between the requesting node and the target node may be established in response to a determination, e.g., upon a determination being made, that the requesting node thereafter performs the predetermined sequence of knocks. Accordingly, in some approaches, a “final” knocking may not be performed on the first of the nodes, and instead, the knocks of the requesting node may be monitored subsequent to and/or in response to a determination that the requesting node has requested to connect to the first other node.

The predetermined sequence of knocks may, in some approaches, additionally and/or alternatively include knocking a predetermined number of times, e.g., once, twice, ten times, one hundred times, etc., on a predetermined third one of the other nodes before sending the request to the first other node. In some of such approaches, knocking may also be performed on the predetermined second other node a second time before sending the request to the first other node. In some approaches, the knocking on the predetermined third other node may be performed after the first knocking on the predetermined second other node is performed and after the second knocking on the predetermined second other node is performed. Accordingly, in some of such approaches, the predetermined sequence of knocks may include the first knock(s) being performed by the requesting node to the second other node, then knock(s) being performed by the requesting node to the third other node, then the second knock(s) being performed by the requesting node to the second other node, and finally knock(s) being performed by the requesting node to the first other node.

The predetermined sequence of knocks may, in some approaches, additionally and/or alternatively include knocking on a predetermined third one of the other nodes before sending the request to the first other node. The knocking on the predetermined third other node may be performed in addition to performing the knocking on the predetermined second other node before sending the request to the first other node. The predetermined sequence may, in some approaches, include a predetermined traffic condition. The predetermined traffic condition must be satisfied in order for it to be determined that the predetermined sequence of knocks has been performed. The predetermined traffic condition may include using a same and/or a different predetermined number of packets for the knocking performed on different predetermined nodes of the other nodes. In some approaches, each packet that is sent by the requesting node along an existing path and received by the node being knocked on is a “knock.” Accordingly, depending on the approach, a single knock may be performed by the requesting node sending a single packet to one of the nodes, a plurality of knocks may be performed on the same node by sending a plurality of packets to the same node, a plurality of knocks may be performed on a plurality of the other nodes by sending packets to the plurality of the other nodes, etc. The other nodes may be configured to monitor associated existing paths for such packets. The predetermined traffic condition may include a first predetermined number of packets, e.g., one packet, ten packets, one hundred packets, etc., for the knocking on the predetermined second other node and/or using a second predetermined number of packets, e.g., one packet, ten packets, one hundred packets, etc., for the knocking on the predetermined third other node. The predetermined number of packets are preferably sent within the same knocking session for a given one of the other nodes as opposed to being distributed over a series of different knocking sessions of knocks being performed on the same node. Furthermore, in some approaches, the first predetermined number may be different than the second predetermined number. In contrast, in some other approaches, the first predetermined number may be the same as the second predetermined number.

One or more temporal conditions may additionally and or alternatively be included in the predetermined sequence of knocks in some approaches. The predetermined temporal conditions must be satisfied in order for it to be determined that the predetermined sequence of knocks has been performed. For example, in one of such approaches, the predetermined temporal condition may include a predetermined delay being observed by the requesting node after knocking on a predetermined one of the other nodes, e.g., such as the second other node, and before sending the request to the first other node. During this intentional delay, the requesting node preferably does not perform any knocks with any of the nodes in the network. In another of such approaches, the predetermined temporal condition may additionally and/or alternatively include the predetermined sequence of knocks being performed by the requesting node within a first predetermined threshold amount of time, e.g., one second, ten seconds, ten minutes, one hour, one day, etc. The predetermined temporal condition may additionally and/or alternatively include a predetermined subset of knocks of the predetermined sequence of knocks being performed by the requesting node within a second predetermined threshold amount of time. The first predetermined threshold amount of time and the second predetermined threshold amount of time may be the same amount of time, or may be different amounts of time. In one example, the predetermined temporal condition may specify that knocks performed on the second other node and a fourth of the other nodes must be performed by the requesting node within a predetermined threshold amount of time, and that the knocks performed on the third other node do not have to be performed by the requesting node within a predetermined threshold amount of time. It may be noted that the predetermined temporal condition may be required to be observed with respect to more than one knocking on a plurality of the different nodes of the network. For example, the predetermined sequence of knocks that includes the predetermined temporal condition may specify that the requesting node is to knock on path AB (that exists between the requesting node and the second other node), wait 3 seconds, and knock on path AC (that exists between the requesting node and the third other node), wait 2 seconds, knock on path AC, knock on path AB, and thereafter is granted access to node D (that exists between the requesting node and the first other node), in response to the requesting node requesting to connect, e.g., knocking, on the first other node.

In some approaches, the predetermined sequence of knocks may additionally and/or alternatively, include a packet variation condition, e.g., that must be satisfied in order for it to be determined that the predetermined sequence of knocks has been performed. For example, the predetermined sequence of knocks may include knocking on the predetermined second other node before sending the request to the first other node, and knocking on the predetermined third other node before the knocking on the predetermined second other node. In such an approach, the predetermined sequence of knocks includes a packet variation condition that includes using an unencrypted version of a packet for the knocking on the predetermined second other node and using an encrypted version of the packet for the knocking on the predetermined third other node. The encryption may be of a type that would become appreciated by one of ordinary skill in the art upon reading the descriptions herein.

The predetermined sequence of knocks that is used may depend on the approach. A degree of complexity that is included in the predetermined sequence of knocks, e.g., a number of knocks included in the predetermined sequence, a number of other nodes that are knocked on during performance of the predetermined sequence of knocks, a number of packets that are included in knocks, etc., may be dynamically assigned in some approaches. For example, in some approaches, in response to a determination that a security threat is present in the network, the relative complexity of the predetermined sequence of knocks that are used may be increased. According to various illustrative approaches, such a security threat being present in the network may be determined based on, e.g., a determination that an unauthorized node has requested to connect with a target node without attempting to perform the predetermined sequence of knocks, a node incorrectly performing the predetermined sequence of knocks, a node incorrectly performing the predetermined sequence of knocks at least a predetermined plurality of times, etc.

In response to a determination that the predetermined sequence of knocks has been performed, e.g., as illustrated by the “Yes” logical path of sub-operation 220, a connection is caused, e.g., instructed, to be established between the requesting node and the first other node, e.g., see operation 206. In some approaches, establishing the connection includes instructing, e.g., a controller of the first other node, the first other node to accept a connection from the requesting node. In another approach, establishing the connection includes instructing the first other node to modify firewall settings and/or rules to allow the requesting node to at least temporarily connect to the first other node. The connection may additionally and/or alternatively be accepted by the first other node in response to the first other node making the determination that the predetermined sequence of knocks has been performed along the existing paths.

The connection may, in some approaches, be a temporary connection. For example, in at least some of such approaches, the connection may be granted for a predetermined amount of time that is determined to be associated with the access credentials of the requesting node. In some other approaches, the connection may be established until, e.g., a loss of connection is determined, a determination is made as to whether the requesting node and/or the first other node initiates a termination of the connection, etc.

In response to a determination that the predetermined sequence of knocks has not been performed, e.g., as illustrated by the “No” logical path of sub-operation 220, a connection is prevented, e.g., instructed to be denied, from being established between the requesting node and the first other node, e.g., see operation 204.

Numerous benefits are enabled as a result of implementing the techniques described in embodiments and approaches herein into networks. For example, in tunneled networking such as an SD-WAN, where nodes are connected via tunneled paths, various embodiments and approaches described herein use a relatively low overhead technique of ensuring that a predetermined sequence of knocks are performed by a requesting node to other nodes of the network before allowing a connection that involves the requesting node to be established. The relatively low amount of overhead caused by these techniques far outweighs the processing resources that would otherwise be consumed to recover from an unauthorized node being able to establish a connection in the network with one of the other nodes. Accordingly, the techniques described herein improve performance of a computer system and within the network by strengthening the security of the network in enforcing the predetermined sequence of knocks. It should also be noted that establishing connections between nodes of a network in response to a determination that a predetermined sequence of knocks has been performed on paths existing between the nodes of the network has heretofore not been considered within conventional networks. Accordingly, the inventive discoveries disclosed herein with regards to use of such predetermined sequence of knocks proceed contrary to conventional wisdom.

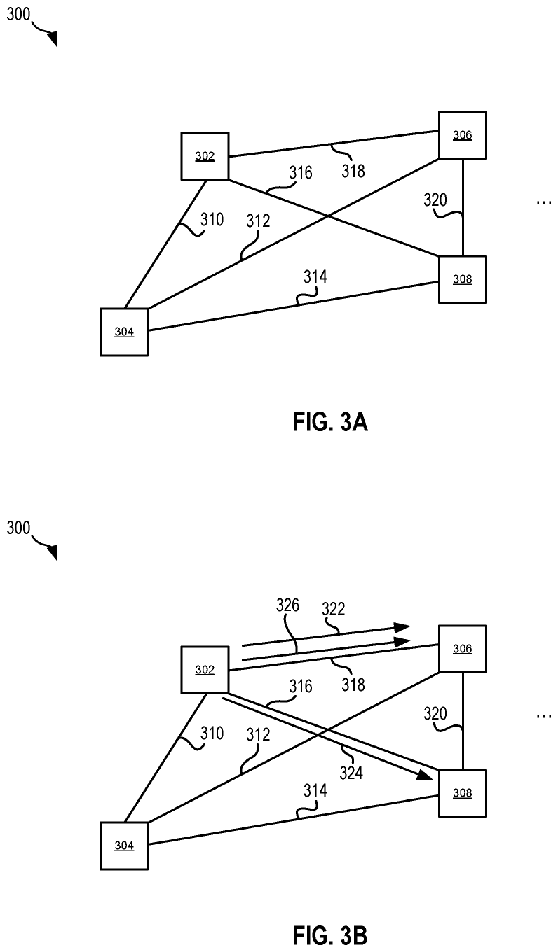

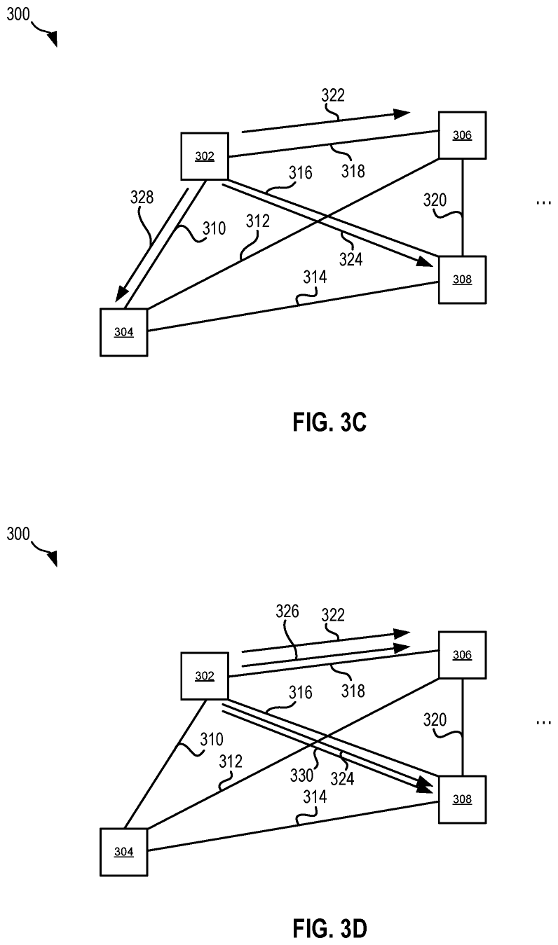

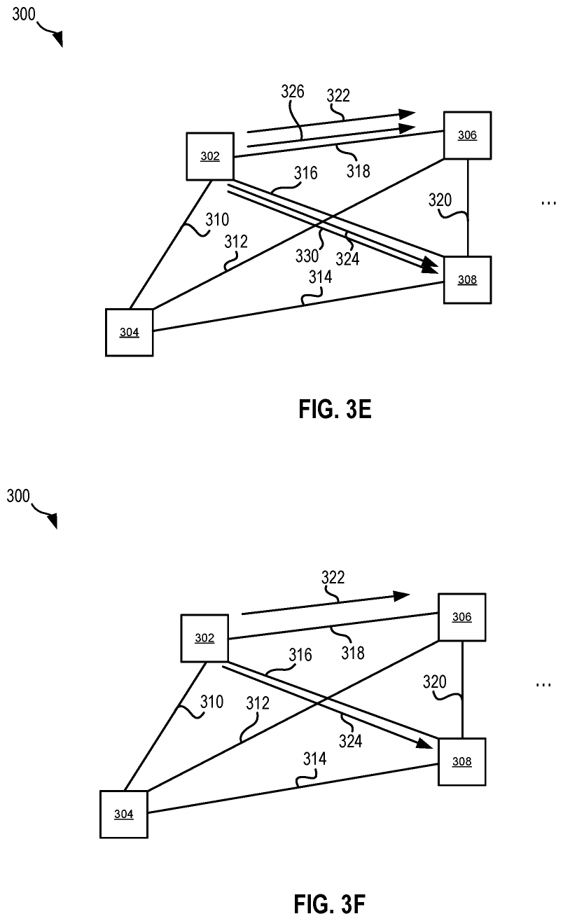

FIGS. 3A-3F depicts a network 300, in accordance with several embodiments. As an option, the present network 300 may be implemented in conjunction with features from any other embodiment listed herein, such as those described with reference to the other FIGS. Of course, however, such network 300 and others presented herein may be used in various applications and/or in permutations which may or may not be specifically described in the illustrative embodiments listed herein. Further, the network 300 presented herein may be used in any desired environment.

It may be prefaced that various operations are included in FIGS. 3B-3F, which may be performed by one or more of the nodes and/or a device controlling one or more of the nodes. Furthermore, some of the FIGS. 3B-3F include common numberings to represent nodes and/or paths and/or operations that may be the same.

Referring first to FIG. 3A, the network 300, which may be a tunneled network, includes a plurality of nodes. For example, the network includes a requesting node 302, and other nodes. The other nodes may include a first of the other nodes 304, which may be a target node that the requesting node requests to connect to by performing a predetermined sequences of knocks. The network 300 additionally includes a second of the other nodes 306, and a third of the other nodes 308. Note that the network 300 may include more or less than the number of nodes shown in FIG. 3A, e.g., see “ . . . ”.

In some approaches, paths, e.g., tunneling paths, may exist between one or more of the nodes. For example, path 310 exists between the requesting node 302 and the first other node 304, path 312 exists between the second other node 306 and the first other node 304, path 314 exists between the third other node 308 and the first other node 304, path 316 exists between the requesting node 302 and the third other node 308, path 318 exists between the requesting node 302 and the second other node 306, and path 320 exists between the second other node 306 and the third other node 308.

Referring now to FIGS. 3B-3F, multiple variations of path knocking according to different predetermined sequences of knocks are illustrated in accordance with several embodiments.

In FIG. 3B, in order to establish a connection between the requesting node 302 and the first other node 304, a determination may be made as to whether a predetermined sequence of knocks has been performed by the requesting node 302 to other nodes of the network 300 along the existing paths 310-320 of the network. In FIG. 3B, the predetermined sequence of knocks includes the requesting node 302 first performing a first knock 322 to the second other node 306 along the existing path 318, then performing a first knock 324 to the third other node 308 along the existing path 316, and then performing a second knock 326 to the second other node 306 along the existing path 318. In some approaches, the predetermined sequence of knocks includes performing the knocks 322 and 326 to the second other node 306 along the existing path 318 each once, but performing two knocks in the first knock 324 operation. In response to a determination that a request, e.g., a knock, received by the first other node 304 includes proof that the predetermined sequence of knocks has been performed by the requesting node 302 to other nodes of the network 300 along the existing paths 310-320 of the network, a connection may be established between the requesting node 302 and the first other node 304.

In FIG. 3C, in order to establish a connection between the requesting node 302 and the first other node 304, a determination may be made as to whether a predetermined sequence of knocks has been performed by the requesting node 302 to other nodes of the network 300 along the existing paths 310-320 of the network. In FIG. 3C, the predetermined sequence of knocks includes the requesting node 302 first performing a first knock 328 to the first other node 304 along the existing path 310, then performing a first knock 322 to the second other node 306 along the existing path 318, and then performing a first knock 324 to the third other node 308 along the existing path 316. In response to a determination that a request, e.g., a knock, received by the first other node 304 includes proof that the predetermined sequence of knocks has been performed by the requesting node 302 to other nodes of the network 300 along the existing paths 310-320 of the network, a connection may be established between the requesting node 302 and the first other node 304. For context, it should be noted that, in some approaches, a second knock may be performed by the requesting node 302 to the first other node 304 along the existing path 310 after the performing the first knock 324, as a part of the predetermined sequence of knocks. In other words, the final knock, e.g., the request, to the first other node 304 by the requesting node may, in some approaches, be included in the predetermined sequence of knocks.

Referring now to FIG. 3D, in order to establish a connection between the requesting node 302 and the first other node 304 a determination may be made as to whether a predetermined sequence of knocks has been performed by the requesting node 302 to other nodes of the network 300 along the existing paths 310-320 of the network. Note that in the current embodiment, the predetermined sequence of knocks includes a temporal variation. For example, in FIG. 3D, the predetermined sequence of knocks includes the requesting node 302 first performing a first knock 322 to the second other node 306 along the existing path 318. The requesting node 302 then waits three seconds before next performing a first knock 324 to the third other node 308 along the existing path 316. After performing the first knock 324 to the third other node 308 along the existing path 316, the requesting node 302 waits two seconds before then performing a second knock 330 on the third other node 308 along the existing path 316, and then performs a second knock 326 to the second other node 306 along the existing path 318. In response to a determination that a request, e.g., a knock, received by the first other node 304 includes proof that the predetermined sequence of knocks and the temporal condition has been performed by the requesting node 302 to other nodes of the network 300 along the existing paths 310-320 of the network, a connection may be established between the requesting node 302 and the first other node 304.

In FIG. 3E, in order to establish a connection between the requesting node 302 and the first other node 304 a determination may be made as to whether a predetermined sequence of knocks has been performed by the requesting node 302 to other nodes of the network 300 along the existing paths 310-320 of the network. In the current embodiment, the predetermined sequence of knocks includes a traffic variation of conditions in which at least some of the knocks are to include a predetermined number of packets. For example, in FIG. 3E, the predetermined sequence of knocks includes the requesting node 302 first performing a first knock 322 to the second other node 306 with three packets along the existing path 318. The requesting node 302 then performing a first knock 324 to the third other node 308 using five packets along the existing path 316. After performing the first knock 324 to the third other node 308 with five packets along the existing path 316, the requesting node 302 then performs a second knock 330 on the third other node 308 with three packets along the existing path 316, before then performing a second knock 326 to the second other node 306 with one packet along the existing path 318. In response to a determination that a request, e.g., a knock, received by the first other node 304 includes proof that the predetermined sequence of knocks and the traffic conditions have been performed by the requesting node 302 to other nodes of the network 300 along the existing paths 310-320 of the network, a connection may be established between the requesting node 302 and the first other node 304.

In FIG. 3F, in order to establish a connection between the requesting node 302 and the first other node 304, a determination may be made as to whether a predetermined sequence of knocks has been performed by the requesting node 302 to other nodes of the network 300 along the existing paths 310-320 of the network. In the current embodiment, the predetermined sequence of knocks includes a packet variation of conditions in which at least some of the knocks are to include an encrypted version of a packet. For example, in FIG. 3F, the predetermined sequence of knocks includes the requesting node 302 first performing a first knock 322 to the second other node 306 with one packet along the existing path 318. The requesting node 302 then performing a first knock 324 to the third other node 308 along the existing path 316 using an encrypted version of the packet included in the first knock 322. In response to a determination that a request, e.g., a knock, received by the first other node 304 includes proof that the predetermined sequence of knocks and the packet conditions have been performed by the requesting node 302 to other nodes of the network 300 along the existing paths 310-320 of the network, a connection may be established between the requesting node 302 and the first other node 304.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining whether a predetermined sequence of knocks has been performed by a requesting node to other nodes of a network along existing paths between the requesting node and the other nodes; and
in response to a determination that the predetermined sequence of knocks has been performed, establishing a connection between the requesting node and a first of the other nodes.

2. The computer-implemented method of claim 1, wherein determining whether the predetermined sequence of knocks has been performed includes: determining whether a request received by the first other node from the requesting node includes proof that the predetermined sequence of knocks has been performed by the requesting node to the other nodes, and comprising: in response to a determination that the received request does not include the proof, preventing a connection from being established between the requesting node and the first other node.

3. The computer-implemented method of claim 2, wherein the proof includes predetermined source routing, wherein a route of knocks previously performed by the requesting node to the other nodes along the existing paths is encapsulated in a packet header included in the received request.

4. The computer-implemented method of claim 2, wherein the proof includes predetermined path marking, wherein the path marking indicates a route of knocks previously performed by the requesting node to the other nodes along the existing paths before sending the request to the first other node.

5. The computer-implemented method of claim 1, wherein the predetermined sequence of knocks includes: knocking on a predetermined second one of the other nodes before sending a request to the first other node.

6. The computer-implemented method of claim 5, wherein the predetermined sequence of knocks includes: knocking a predetermined number of times on a predetermined third one of the other nodes before sending the request to the first other node, and knocking on the predetermined second other node a second time before sending the request to the first other node, wherein the knocking on the predetermined third other node is performed after the first knocking on the predetermined second other node is performed and after the second knocking on the predetermined second other node is performed.

7. The computer-implemented method of claim 5, wherein the predetermined sequence of knocks includes: knocking on a predetermined third one of the other nodes before sending the request to the first other node, wherein the predetermined sequence includes a predetermined traffic condition, wherein the predetermined traffic condition includes: using a first predetermined number of packets for the knocking on the predetermined second other node and/or using a second predetermined number of packets for the knocking on the predetermined third other node.

8. The computer-implemented method of claim 1, wherein the predetermined sequence includes at least one predetermined temporal condition, wherein the predetermined temporal condition is selected from the group consisting of: a predetermined delay being observed by the requesting node after knocking on a predetermined second one of the other nodes and before sending a request to the first other node, the predetermined sequence of knocks being performed by the requesting node within a first predetermined threshold amount of time, a predetermined subset of knocks of the predetermined sequence of knocks being performed by the requesting node within a second predetermined threshold amount of time.

9. The computer-implemented method of claim 1, wherein the predetermined sequence of knocks includes: knocking on a predetermined second one of the other nodes before sending a request to the first other node, and knocking on a predetermined third one of the other nodes before the knocking on the predetermined second other node, and wherein the predetermined sequence includes a packet variation condition, wherein the packet variation condition includes using an unencrypted version of a packet for the knocking on the predetermined second other node and using an encrypted version of the packet for the knocking on the predetermined third other node.

10. A computer program product, the computer program product comprising a computer readable storage medium having program instructions embodied therewith, the program instructions readable and/or executable by a computer to cause the computer to:
determine, by the computer, whether a predetermined sequence of knocks has been performed by a requesting node to other nodes of a network along existing paths between the requesting node and the other nodes; and
in response to a determination that the predetermined sequence of knocks has been performed, establish, by the computer, a connection between the requesting node and a first of the other nodes.

11. The computer program product of claim 10, wherein determining whether the predetermined sequence of knocks has been performed includes: determining whether a request received by the first other node from the requesting node includes proof that the predetermined sequence of knocks has been performed by the requesting node to the other nodes, and the program instructions readable and/or executable by the computer to cause the computer to: in response to a determination that the received request does not include the proof, prevent, by the computer, a connection from being established between the requesting node and the first other node.

12. The computer program product of claim 11, wherein the proof includes predetermined source routing, wherein a route of knocks previously performed by the requesting node to the other nodes along the existing paths is encapsulated in a packet header included in the received request.

13. The computer program product of claim 11, wherein the proof includes predetermined path marking, wherein the path marking indicates a route of knocks previously performed by the requesting node to the other nodes along the existing paths before sending the request to the first other node.

14. The computer program product of claim 10, wherein the predetermined sequence of knocks includes: knocking on a predetermined second one of the other nodes before sending a request to the first other node.

15. The computer program product of claim 14, wherein the predetermined sequence of knocks includes: knocking a predetermined number of times on a predetermined third one of the other nodes before sending the request to the first other node, and knocking on the predetermined second other node a second time before sending the request to the first other node, wherein the knocking on the predetermined third other node is performed after the first knocking on the predetermined second other node is performed and after the second knocking on the predetermined second other node is performed.

16. The computer program product of claim 14, wherein the predetermined sequence of knocks includes: knocking on a predetermined third one of the other nodes before sending the request to the first other node, wherein the predetermined sequence includes a predetermined traffic condition, wherein the predetermined traffic condition includes: using a first predetermined number of packets for the knocking on the predetermined second other node and/or using a second predetermined number of packets for the knocking on the predetermined third other node.

17. The computer program product of claim 10, wherein the predetermined sequence includes at least one predetermined temporal condition, wherein the predetermined temporal condition is selected from the group consisting of: a predetermined delay being observed by the requesting node after knocking on a predetermined second one of the other nodes and before sending a request to the first other node, the predetermined sequence of knocks being performed by the requesting node within a first predetermined threshold amount of time, a predetermined subset of knocks of the predetermined sequence of knocks being performed by the requesting node within a second predetermined threshold amount of time.

18. The computer program product of claim 10, wherein the predetermined sequence of knocks includes: knocking on a predetermined second one of the other nodes before sending a request to the first other node, and knocking on a predetermined third one of the other nodes before the knocking on the predetermined second other node, and wherein the predetermined sequence includes a packet variation condition, wherein the packet variation condition includes using an unencrypted version of a packet for the knocking on the predetermined second other node and using an encrypted version of the packet for the knocking on the predetermined third other node.

19. A system, comprising:
a processor; and
logic integrated with the processor, executable by the processor, or integrated with and executable by the processor, the logic being configured to:
determine whether a predetermined sequence of knocks has been performed by a requesting node to other nodes of a network along existing paths between the requesting node and the other nodes; and
in response to a determination that the predetermined sequence of knocks has been performed, establish a connection between the requesting node and a first of the other nodes.

20. The system of claim 19, wherein determining whether the predetermined sequence of knocks has been performed includes: determining whether a request received by the first other node from the requesting node includes proof that the predetermined sequence of knocks has been performed by the requesting node to the other nodes, and the logic being configured to: in response to a determination that the received request does not include the proof, prevent a connection from being established between the requesting node and the first other node.
